(19) United States
(12) Patent Application Publication
(10) Pub. No.: US 2009/0194491 A1
(43) Pub. Date: Aug. 6, 2009

(54) INTERACTIVE MEDIA STORAGE SYSTEM

(76) Inventor: Michael Lichodziejewski, Chicago, IL (US)

Correspondence Address: Michael Lichodziejewski, 1232 West Glenlake Avenue, Chicago, IL, 60660, US

(21) Appl. No.: 12/349,395

(22) Filed: Jan. 6, 2009

Related U.S. Application Data
(60) Provisional application No. 61/010,437, filed on Jan. 9, 2008.

(51) Int. Cl. A47B 65/00; G06N 5/00

(52) U.S. Cl. 211/42; 706/45

(57) ABSTRACT

An interactive media storage system is disclosed. Specifically, the system can detect the insertion or removal of media items, such as books, and respond. The system may also track individual media items and/or the person or persons who remove and insert said media items for security and historical purposes. A version wherein the media storage system responds “in character” when characters are associated with the media items (e.g. for use with children's books) is also disclosed.

### OBJECTS OF THE INVENTION

An object of the invention is to provide an interactive media storage system.

A second object of the invention is to provide a system which provides active response to a media item being stored in an appropriate or inappropriate location.

A third object of the invention is to provide a system which will encourage users to interact with media items in a variety of contexts.

Other objects and advantages of the invention will become apparent in the following disclosure.

### SUMMARY OF THE INVENTION

The present invention relates to a system for storing media items wherein a storage means such as a shelf, rack, box or case can detect the insertion and/or removal of a media items and respond in a predetermined manner. The system is suitable for a wide variety of applications, such as a children's book storage system which is keyed to books and responds in the voice of a character or by encouraging a child to read or a storage system for professional books which ensures that books are replaced in an orderly manner. The system can also track the identity of a person or persons inserting or removing media items.

### BRIEF DESCRIPTION OF THE DRAWINGS

The characteristic features of the invention will be particularly pointed out in the claims. The descriptions of the preferred embodiment refer to the preceding drawings:

FIG. 1 is a representational view of the entire apparatus.

FIG. 2 is a representational view of the apparatus with an interactive means in active mode.

### DESCRIPTION OF THE PREFERRED EMBODIMENT

The description of the preferred embodiment uses the invention in a device which stores children's books and recognizes them as they are inserted or removed from the storage area. While the description refers to “books,” the media involved could be DVD's, videocassettes, CD's, or any other appropriate media which is suitable for storage in a base.

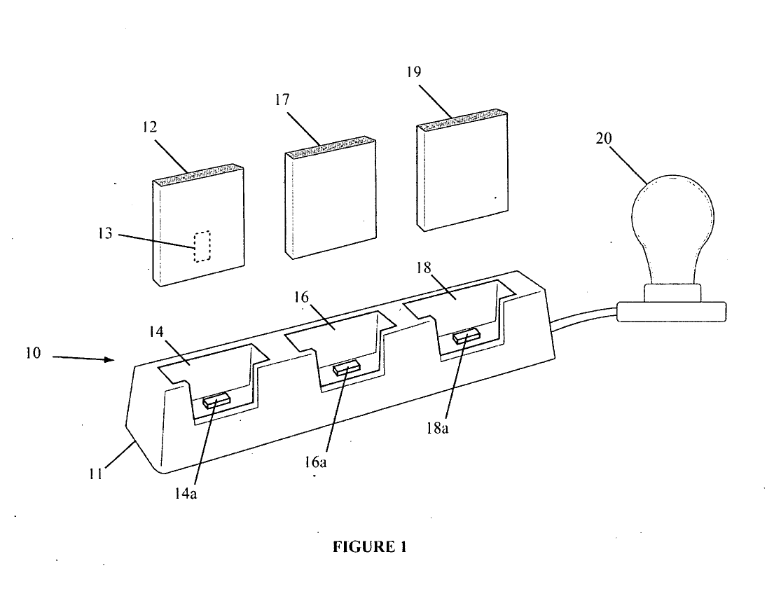

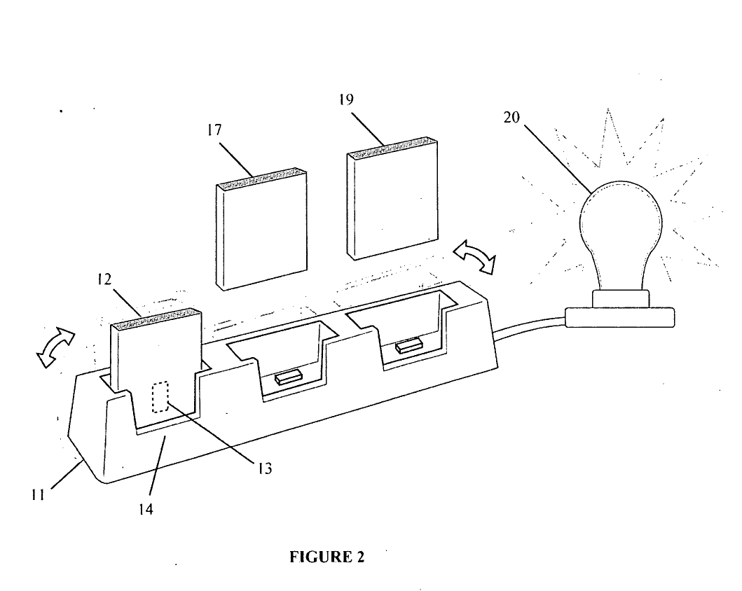

By referring to FIG. 1, the basic concept of the invention may be easily understood. Apparatus 10 comprises base 11 and book 12. Base 11 contains slots 14, 16, and 18. Each slot contains a switch 14a, 16a, and 18a. When book 12 is inserted into slot 14, it activates switch 14a, which causes the system to react (see FIG. 2.) Alternatively, base 11 could hold one of many known sensor mechanisms, such as a barcode reader, capacitance sensor, or RFID tag sensor, which would then respond to readable ID tag 13. Furthermore, base 11 could do both—using switch 14a to detect a book, and reading readable ID tag 13 if present or identifying the book as a non-tagged book if its presence is detected but no ID tag is found.

FIG. 2 shows the system responding to the insertion of a book. By closing switch 14a (not shown: see FIG. 1) a motor in the unit causes it to respond via vibration or other mechanical response and light bulb 20 lights up. Such means of responding to simple switch inputs are old in the art and are not detailed in this application. Placing book 12 in a different slot would likewise produce a response, which could be identical, or keyed to the individual slot, or keyed to the placement of a given book in a given slot, or otherwise, as determined by the desired application of the invention.

The description of the figures above demonstrates the most basic embodiment of the invention, but further refinements could be added to increase the interactivity of the system and its responsiveness to a given book or books. For instance, each book could contain a Radio Frequency Identification (RFID) tag and the base could contain a corresponding RFID reader, such that the base could respond appropriately to a given book. In an embodiment for children, the reader could respond by encouraging the child to enjoy the book when it is removed and thanking them for returning it when it is inserted, possibly in the voice of one or more of the characters in the book. In an embodiment for tracking books, the RFID tags could be tracked by time, with a secondary RFID tag keyed to individual users allowing the system to know who removed a given book, when it was removed, and when and if it was replaced. The user identification means could also be an input sequence, a swiped card, or any other suitable identification means. The means of identifying the books may also be embodied in a variety of ways, such as physical key shapes, capacitance tags, conductive inks with or without integrated inductance devices which are detectable by sensors, or appropriately placed barcodes or other symbols with corresponding reader means incorporated into the system.

While the description above details the preferred and best mode(s) of practicing the invention, many other configurations and variations are possible. For example:
1) The invention need not be practiced as a standalone interactive book storage system, but could be a scoring or playing element in a game of chance or skill.
2) The system could be integrated into a larger tracking and security system for securing materials and equipment.
   Accordingly, the scope of the invention should be determined not by the embodiment(s) illustrated, but by the claims below and their equivalents.

What is claimed is:

1) An interactive media storage system comprising:
A) A base unit having an area which can receive one of a plurality of media items;
B) A means for detecting when the area receives one of the plurality of media items; and,
C) A means for responding to the means for detecting when the area receives one of the plurality of media items.

2) An interactive media storage system as in claim 1, further comprising:
F) A means for identifying a plurality of individual users who can remove one of the plurality of media items; and,
G) A means for tracking the individual users and the plurality of media items which they may remove so that the interactive media storage system can reveal which of the individual user removed which of the media items.

3) An interactive media storage system as in claim 1, further comprising:
F) A plurality of characters associated with at least one of the plurality of media items; and,
G) A means of having the interactive media storage system respond to the insertion or removal of one of the plurality of media items with a plurality of responses, wherein the plurality of responses have a plurality of traits associated with the plurality of characters associated with the plurality of media items.

4) An interactive media storage system comprising:
A) A base unit having a plurality of receiving areas, each receiving area having a sensor;
B) A plurality of media items, each media item having a readable characteristic;
C) A detection monitor which monitors the sensors in the plurality of receiving areas; and,
D) An indicator which communicates with the detection monitor and which gives an indication communication when the detection monitor indicates that the readable characteristic of one of the media items has been detected by one of the sensors.

5) An interactive media storage system as in claim 4, further comprising:
E) A plurality of user identifications, each user identification being associated with a particular user; and,
F) A user identification reader in the base unit capable of detecting user identifications and identifying the particular user associated with each particular user.

6) An interactive media storage system as in claim 4 wherein each media item is associated with a particular receiving area of the plurality of receiving areas, and in which the indicator indicates by an erroneous indication communication when one of the media items is placed into one of the plurality of receiving areas which is not the particular receiving area associated with that media item.

7) An interactive media storage system as in claim 4 wherein each media item is associated with a particular receiving area of the plurality of receiving areas, and in which the indicator indicates by a correct indication communication when one of the media items is placed into one of the plurality of receiving areas which is the particular receiving area associated with that media item.

8) An interactive media storage system as in claim 5 wherein each media item is associated with a particular receiving area of the plurality of receiving areas, and in which the indicator indicates by an erroneous indication communication when one of the media items is placed into one of the plurality of receiving areas which is not the particular receiving area associated with that media item.

9) An interactive media storage system as in claim 5 wherein each media item is associated with a particular receiving area of the plurality of receiving areas, and in which the indicator indicates by a correct indication communication when one of the media items is placed into one of the plurality of receiving areas which is the particular receiving area associated with that media item.

10) An interactive media storage system as in claim 4, further comprising:
E) A plurality of characters, each character being associated with at least one of the plurality of media items;
F) An electronic storage unit which stores a plurality of communications, each of the plurality of communications being associated with one of the plurality of characters;
G) An electronic communications unit which can communicate the plurality of communications to a user; and,
H) An electronic logic unit which receives input from the detection monitor when one of the plurality of media items is placed in one of the plurality of receiving areas and directs the electronic communications unit to communicate one of the plurality of communications to the user according to a logical scheme.

11) An interactive media storage system as in claim 4, further comprising:
E) An electronic storage unit which stores a plurality of communications;
F) An electronic communications unit which can communicate the plurality of communications to a user; and,
G) An electronic logic unit which receives input from the detection monitor when one of the plurality of media items is placed in one of the plurality of receiving areas and directs the electronic communications unit to communicate one of the plurality of communications to the user according to a logical scheme.
